(19) United States
(12) Patent Application Publication
(10) Pub. No.: US 2001/0026435 A1
(43) Pub. Date: Oct. 4, 2001

(54) Monolithic ceramic electronic component, method for manufacturing same, and electronic device including same

(76) Inventor: Norio Sakai, Moriyama-shi (JP)

Correspondence Address: Keating & Bennett LLP, 10400 Eaton Place, Suite 312, Fairfax, VA, 22030, US

(21) Appl. No.: 09/788,694

(22) Filed: Feb. 20, 2001

(30) Foreign Application Priority Data
Mar. 29, 2000 (JP) 2000-090465

(51) Int. Cl. H01G 4/228

(52) U.S. Cl. 361/306.3

(57) ABSTRACT

A monolithic ceramic component includes a laminate member having a plurality of ceramic layers and wiring conductors including at least one line conductor and at least one via-hole conductor. The line conductor is provided with a connecting land having a diameter greater than the diameter of the via-hole conductor, and the line conductor is connected to the via-hole conductor with the connecting land therebetween while the via-hole conductor is positioned in the approximate center of the connecting land.

### BACKGROUND OF THE INVENTION

1. Field of the Invention

The present invention relates to a monolithic ceramic electronic component and to a method for manufacturing a monolithic ceramic electronic component, and relates to an electronic device including such a monolithic ceramic electronic component. More particularly, the present invention relates to an improvement in the connecting structure between a via-hole conductor and a line conductor provided in a monolithic ceramic electronic component.

2. Description of the Related Art

The monolithic ceramic electronic component to which the present invention is directed is also called a multilayered ceramic substrate and includes a laminate having a plurality of ceramic layers.

In the laminate, wiring conductors are arranged so that a desired circuit is defined by passive elements, such as capacitors, inductors, and resistors. On the laminate, active elements, such as semiconductor IC chips, and if necessary, some passive elements are mounted.

The composite monolithic ceramic electronic component as described above is mounted on an appropriate wiring substrate so as to form a desired electronic device.

Such monolithic ceramic electronic components are used, for example, in the mobile communication terminal equipment field as LCR composite high-frequency parts, and in the computer field as composite components which includes active elements, such as semiconductor IC chips, and passive elements, such as capacitors, inductors, and resistors, or merely as semiconductor IC packages.

More specifically, monolithic ceramic electronic components are widely used in various types of electronic components, such as module substrates, RF diode switches, filters, chip antennas, various package parts, and composite devices.

Examples of wiring conductors provided in the laminate are via-hole conductors extending through ceramic layers, and line conductors extending along interfaces between ceramic layers. At least some of the line conductors provided in the laminate are connected to via-hole conductors at the interfaces between ceramic layers.

FIG. 3 shows a method for forming a via-hole conductor.

A ceramic green sheet 1 for forming a ceramic layer is handled while attached to and backed by a carrier film 2. A through-hole 3 is formed through the ceramic green sheet 1 and the carrier film 2. The ceramic green sheet 1 backed by the carrier film 2 is placed on a vacuum apparatus 4.

The vacuum apparatus 4 includes a vacuum chamber 5, and a negative pressure is applied to the vacuum chamber 5 as indicated by arrows 6. The opening of the vacuum chamber 5 is closed by a suction plate 7, which is provided with many small air paths (not shown in the drawing).

A porous sheet 8 composed of paper or other filtering material is placed on the upper surface of the suction plate 7. The porous sheet 8 is provided with a smooth surface at least on the upper surface thereof. The ceramic green sheet 1 is placed so as to be in contact with the porous sheet 8, and the carrier film 2 is positioned on the upper surface of the ceramic green sheet 1.

In such a state, when a negative pressure is applied to the vacuum chamber 5 as indicated by the arrows 6, the negative pressure acts at the inside of the through-hole 3 via the suction plate 7 and the porous sheet 8.

In this state, a conductive paste 9 is applied to the upper side of the carrier film 2. The conductive paste 9 is moved onto the carrier film 2 by moving a squeegee 10 along the upper surface of the carrier film 2, and the conductive paste 9 is filled into the through-hole 3 by the effect of the negative pressure during the squeegeeing process. By filling the thorough-hole 3 with the conductive paste 9 from the side of the carrier film 2, while using the carrier film 2 as a mask as described above, a via-hole conductor 11 is formed in the through-hole 3.

Next, the ceramic green sheet 1 backed with the carrier film 2 is detached from the porous sheet 8, and as shown in FIG. 4, by printing the conductive paste on the principal surface on the side of the ceramic green sheet 1, followed by drying, a line conductor 12 is formed. The line conductor 12 is connected to the via-hole conductor 11.

Next, the ceramic green sheet 1 is separated from the carrier film 2, and a plurality of ceramic green sheets, including the ceramic green sheet 1, are laminated together. At this stage, the line conductor 12 shown in FIG. 4 is located at the interface between the ceramic green sheet 1 and a ceramic green sheet adjacent thereto.

A green laminate thus obtained is pressed, for example, at a pressure of 500 kg/cm² to 1,500 kg/cm² at 50° C. to 100° C., and is then fired, and thus, a desired monolithic ceramic electronic component is obtained.

As described above, until the ceramic green sheet 1 is laminated, the ceramic green sheet 1 is handled while being backed with the carrier film 2. The reason for this is that since the ceramic green sheet 1 has a very low strength and is soft and brittle, it is extremely difficult to handle it alone. By backing the ceramic green sheet 1 with the carrier film 2, the handling thereof is facilitated, the alignment of the ceramic green sheet 1 in the individual steps is possible, and also variations in the shrinkage of the ceramic green sheet 1 do not easily occur when the conductive paste for forming the via-hole conductor 11 and the line conductor 12 is dried.

As described above, since the carrier film 2 is used as a mask when the through-hole 3 is filled with the conductive paste in-order to form the via-hole conductor 11, in contrast to a method in which the through-hole 3 is filled with the conductive paste by screen printing, it is not necessary to separately prepare a screen or to align the screen, which makes the process less expensive.

When the through-hole 3 is filled with the conductive paste by screen printing, the conductive paste must be applied to an area which is larger than the opening of the through-hole 3 because of alignment accuracy, and therefore the conductive paste is applied in a protruding state around the opening of the through-hole 3. Thus, a protruding land is always formed in relation to a via-hole conductor. In contrast, by applying the conductive paste using the carrier film 2 as a mask, it is possible to form the via-hole conductor 11 without such a protruding land. Therefore, the area required for forming the via-hole conductor 11 can be reduced, thus enabling a reduction in the size of the monolithic ceramic electronic component as well as achieving an increase in the density of wiring.

With respect to the reduction in the size of the monolithic ceramic electronic component and the increase in the density of the wiring, for example, at present, in the via-hole conductor 11, the diameter thereof is decreased to 150 μm, 100 μm, or 75 μm, and in the line conductor 12, the width thereof is decreased to 100 μm, 50 μm, or 30 μm.

As described above, the width of the line conductor 12 can be easily decreased, for example, to approximately 30 μm, by advances in printing technology. However, although it is possible to simply decrease the diameter of the via-hole conductor 11, the diameter must be larger than a certain value in view of the lamination accuracy of the ceramic green sheet 1. That is, in order to properly connect the via-hole conductors 11 that are adjacent in the lamination direction to each other in spite of unavoidable deviations in lamination position in the lamination process of the ceramic green sheet 1, the lower limit of the diameter of the via-hole conductor 11 is approximately 75 μm as described above.

As a result, as shown in FIG. 5, in the dimensional relationship between the via-hole conductor 11 and the line conductor 12 connected thereto, the width of the line conductor 12 may become less than the diameter of the via-hole conductor 11. In such a case, in particular, as shown in FIG. 6, disconnection or other defects may occur between the via-hole conductor 11 and the line conductor 12, resulting in connection failure. A connection failure may occur, for example, due to the reasons described below.

The amount of the conductive paste filled in the through-hole 3 for forming the via-hole conductor 11 may be insufficient or may be excessive.

That is, after the through-hole 3 is filled with the conductive paste 9 in the step shown in FIG. 3, for example, when the porous sheet 8 is detached from the ceramic green sheet 1, as shown in FIG. 7, a portion of the conductive paste 9 may adhere to the porous sheet 8, and therefore, the amount of the conductive paste 9 in the through-hole 3 may become insufficient.

When the carrier film 2 is separated from the ceramic green sheet 1, as shown in FIG. 8, a portion of the conductive paste 9, which has been located in the through-hole 3 of the carrier film 2, may remain on the side of the ceramic green sheet 1, and therefore, the amount of the conductive paste 9 in the through-hole 3 of the ceramic green sheet 1 may become excessive.

In the state in which the thorough-hole 3 is insufficiently filled with the conductive paste 9, as shown in FIG. 7, when a plurality of ceramic green sheets 1 are laminated together and pressed as shown in FIG. 9A, the line conductor 12 may be distorted or bent due to the flowing of the material in the ceramic green sheet 1 as shown in FIG. 9B.

In the state in which the through-hole 3 is filled with an excess of conductive paste 9, as shown in FIG. 8, when a plurality of ceramic green sheets 1 are laminated together and pressed as shown in FIG. 10A, the line conductor 12 may also be distorted or bent due to the flowing of the material in the ceramic green sheet 1, as shown in FIG. 10B.

When the width of the line conductor 12 is less than the diameter of the via-hole conductor 11 as shown in FIG. 5, due to the distortion or bending described above, disconnection easily occurs between the via-hole conductor 11 and the line conductor 12 as shown in FIG. 6.

Additionally, the connection failure between the via-hole conductor 11 and the line conductor 12 as described above easily occurs, in particular, when such a connecting section is located in a green laminate. When the connecting section is located on the outer surface of the green laminate, even if insufficient filling or excessive filling of the conductive paste 9 for forming the via-hole conductor 11 occurs, such a state is easily corrected using a flat surface of a mold in the pressing step, thus avoiding the distortion or bending of the line conductor 12.

The connection failure between the via-hole conductor 11 and the line conductor 12 as shown in FIG. 6 may also occur in the case described below.

That is, since the ceramic green sheet 1 is thin, for example, with a thickness of 25 μm to 300 μm, and is brittle, fragments of the ceramic green sheet 1 are easily produced. If the fragments adhere to a portion of the back surface of a screen for printing the line conductor 12, the conductive paste for forming the line conductor 12 is not printed at the location of such a portion. If the unprinted portion happens to lie on a connecting section between the via-hole conductor 11 and the line conductor 12, since the width of the line conductor 11 is originally small, there is a high probability of a connection failure.

### SUMMARY OF THE INVENTION

In order to overcome the problems described above, preferred embodiments of the present invention provide a monolithic ceramic electronic component which is constructed to reliably prevent connection failures and other defects while providing a very easy and inexpensive manufacturing process, and also provide a method for manufacturing the monolithic ceramic electronic component, and provide an electronic device including such a monolithic ceramic electronic component.

According to one preferred embodiment of the present invention, a monolithic ceramic electronic component includes a laminate having a plurality of ceramic layers, and wiring conductors provided on selected ones of the ceramic layers, the wiring conductors including at least one via-hole conductor extending through the ceramic layers and at least one line conductor extending along an interface between the ceramic layers, the line conductor has a width which is substantially equal to or less than the diameter of the via-hole conductor, and the line conductor is connected to the via-hole conductor at the interface. In order to overcome the technical difficulties described above, the line conductor is provided with a connecting land having a diameter which is greater than the diameter of the via-hole conductor, and the line conductor is connected to the via-hole conductor with the connecting land therebetween while the via-hole conductor is positioned in the approximate center of the connecting land.

In the monolithic ceramic electronic component, preferably, the line conductor and the connecting land are integrally formed.

Preferably, the connecting land is positioned at an end of the line conductor, i.e., the end of the line conductor is connected to the via-hole conductor. In such a case, this preferred embodiment of the present invention is particularly effective.

Preferably, the via-hole conductor has a diameter of about 75 μm to about 150 μm, and the line conductor has a width of about 30 μm to about 100 μm. When the diameter and the width are decreased as described above, preferred embodiments of the present invention are particularly effective. In such a case, preferably, the connecting land has a diameter which is greater than the diameter of the via-hole conductor by about 100 μm to about 200 μm.

Preferably, the via-hole conductor has micropores therein.

In another preferred embodiment of the present invention, a method for manufacturing a monolithic ceramic electronic component includes the steps of preparing a plurality of ceramic green sheets, each ceramic green sheet being backed with a carrier film, forming a through-hole through the ceramic green sheet and the carrier film, injecting a conductive paste into the through-hole from the side of the carrier film using the carrier film as a mask in order to form a via-hole conductor in the through-hole, applying the conductive paste by printing on a principal surface of the ceramic green sheet backed with the carrier film in order to form a line conductor to be connected to the via-hole conductor, separating the carrier film from the ceramic green sheet, producing a green laminate by laminating the plurality of ceramic green sheets so that the line conductor is positioned at an interface between predetermined ceramic green sheets, and firing the green laminate. In the step of applying the conductive paste for forming the line conductor, a connecting land having a diameter which is greater than the diameter of the via-hole conductor is formed while the via-hole conductor is positioned in the approximate center of the connecting land.

In the method for manufacturing the monolithic ceramic electronic component, preferably, the connecting land is formed so as to have a pattern overlapping with an end surface of the via-hole conductor.

In another preferred embodiment of the present invention, an electronic device includes the monolithic ceramic electronic component, such as the one according to the preferred embodiment described above, and a wiring substrate for mounting the monolithic ceramic electronic component.

Other features, elements, characteristics and advantages of the present invention will become more apparent from the detailed description of preferred embodiments thereof with reference to the drawings.

### BRIEF DESCRIPTION OF THE DRAWINGS

FIG. 1 is an enlarged sectional view of the portion A which is circled in FIG. 2, taken along the line I-I of FIG. 2, which illustrates a principal section of a monolithic ceramic electronic component according to a preferred embodiment of the present invention;

FIG. 2 is a sectional view that schematically shows the overall structure of the monolithic ceramic electronic component shown in FIG. 1;

FIG. 3 is a sectional view that schematically shows a step of forming a via-hole conductor for the purpose of describing a conventional technique;

FIG. 4 is a sectional view that shows a state in which a line conductor 12 is formed on a ceramic green sheet shown in FIG. 3;

FIG. 5 is a plan view showing the via-conductor and the line conductor shown in FIG. 4;

FIG. 6 is a plan view, corresponding to FIG. 5, showing a state in which a connection failure occurs between the via-hole conductor and the line conductor;

FIG. 7 is a sectional view which schematically shows a state in which insufficient filling of a conductive paste occurs in a through-hole of the ceramic green sheet;

FIG. 8 is a sectional view which schematically shows a state in which excessive filing of the conductive paste occurs in the through-hole of the ceramic green sheet;

FIGS. 9A and 9B are sectional views showing a step of laminating a plurality of ceramic green sheets 1 when the insufficient filling of the conductive paste occurs as shown in FIG. 7, and a state after pressing, respectively; and

FIGS. 10A and 10B are sectional views showing a step of laminating a plurality of ceramic green sheets when the excessive filling of the conductive paste occurs as shown in FIG. 8, and a state after pressing, respectively.

### DETAILED DESCRIPTION OF PREFERRED EMBODIMENTS

FIGS. 1 and 2 show a monolithic ceramic electronic component 21 according to a preferred embodiment of the present invention. FIG. 2 schematically shows the monolithic ceramic electronic component 21, and FIG. 1 is an enlarged sectional view of the circled portion A in FIG. 2, taken along the line I-I of FIG. 2.

The monolithic ceramic electronic component 21 includes a laminate member 23 having of a plurality of ceramic layers 22. In the laminate member 23, various wiring conductors 24 are provided in relation to predetermined ceramic layers 22.

Examples of the wiring conductors 24 are via-hole conductors 25 extending through predetermined ceramic layers 22, internal conductive films 26 extending along predetermined interfaces between the ceramic layers 22, and external conductive films 27 provided on the outer surfaces of the laminate member 23.

Some of the internal conductive films 26 constitute line conductors 28, and as a line conductor 28, there is the one as shown in FIG. 1, in which a width w thereof is less than a diameter d of the via-hole conductor 25.

The line conductor 28 having the dimensional relationship described above has a connecting land 29 having a diameter D which is greater than the diameter d of the via-hole conductor 25. The line conductor 28 is connected to the via-hole conductor 25 with the connecting land 29 therebetween.

When the size of the monolithic ceramic electronic component 21 is reduced and the density of wiring is increased, the diameter d of the via-hole conductor 25 is preferably decreased to approximately about 75 μm to about 150 μm, and the width w of the line conductor 28 is decreased to approximately 30 μm to about 100 μm.

In such a case, the diameter D of the connecting land 29 is preferably arranged to protrude by approximately 50 μm to about 100 μm from the periphery of the via-hole conductor 25, i.e., it is preferably greater than the diameter d of the via-hole conductor 25 by about 100 μm to about 200 μm.

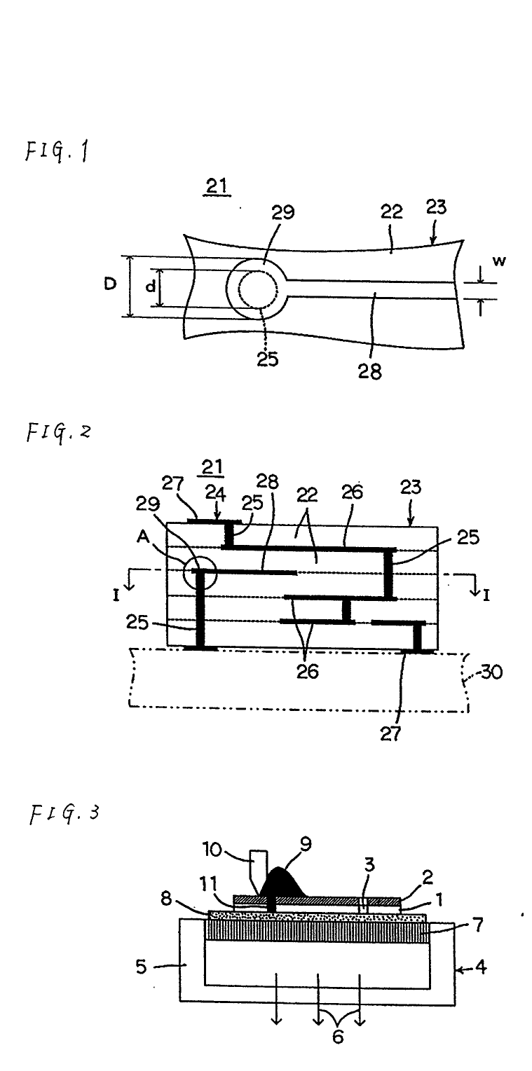

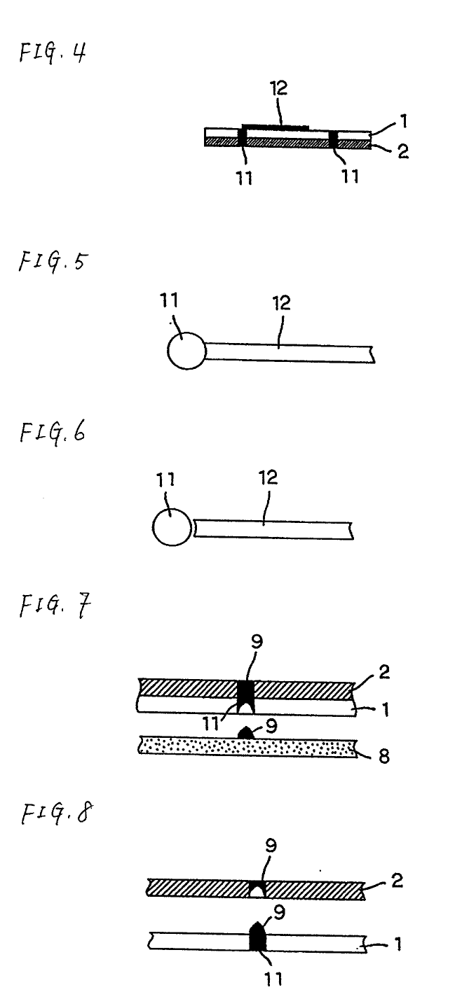

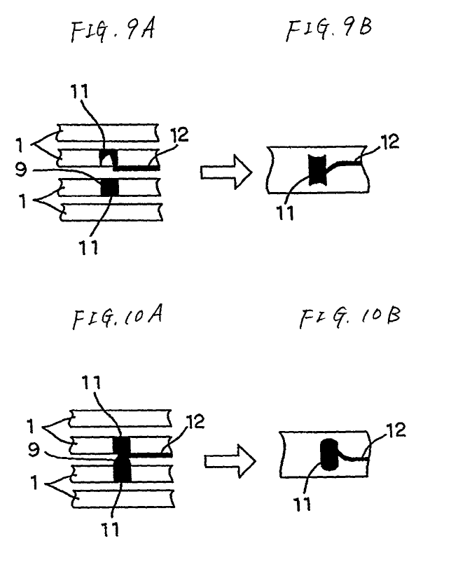

In order to manufacture the monolithic ceramic electronic component 21, basically, substantially the same method as the conventional method described with reference to FIGS. 3 and 4 may be used.

That is, a plurality of ceramic green sheets, each backed with a carrier film, are prepared. A through-hole is formed through the ceramic green sheet and the carrier film, and a conductive paste is injected into the through-hole from the side of the carrier-film while using the carrier film as a mask in order to form the via-hole conductor 25 in the through-hole.

Next, in order to form the line conductor 28 to be connected to the via-hole conductor 25, the conductive paste is printed on a principal surface of the ceramic green sheet backed with the carrier film. In the printing step, simultaneously with the formation of the line conductor 28, the connecting land 29 having the diameter D which is greater than the diameter d of the via-hole conductor 25 is also formed while the via-hole conductor is positioned in the approximate center of the connecting land 29. In such a case, although the connecting land 29 may be formed only in the region excluding the end surface of the via-hole conductor 25, for example, in a ring shape, the connecting land 29 is preferably formed so as to have a pattern overlapping with the end surface of the via-hole conductor 25.

As the conductive paste used for forming the wiring conductors 24 including the via-hole conductor 25 and the line conductor 28, a paste containing any one of Ag, Ag—Pd, Ag—Pt, Cu, CuO, and Ni, or other suitable material may be used.

Next, the carrier film is separated from the ceramic green sheet, and by laminating a plurality of ceramic green sheets so that the line conductor 28 is positioned at the interface between predetermined ceramic green sheets, a green laminate is produced. By pressing and firing the green laminate, a monolithic ceramic electronic component 21 as shown in FIG. 2 can be obtained.

The monolithic ceramic electronic component 21 is, for example, mounted on a wiring substrate 30 as indicated by a phantom line in FIG. 2, and thus constitutes a desired electronic device.

Preferably, the via-hole conductor 25 has micropores therein. By forming micropores in the via-hole 25, it is possible to match the firing shrinkage of the ceramic layer 22 with that of the via-hole conductor 25, and thus disconnection between the via-hole conductor 25 and the line conductor 26 can be more effectively prevented.

Additionally, when the via-hole conductor having micropores and the line conductor having a width that is substantially equal to or less than the diameter of the via-hole conductor are merely directly connected to each other, continuity between the line conductor and the via-hole conductor may be degraded due to a decrease in the contact area between the individual conductors. Even in such a case, by connecting the via-hole conductor to the line conductor with the connecting land, which has a larger diameter than that of the via-hole conductor, therebetween in accordance with preferred embodiments of the present invention, continuity between the via-hole conductor and the line conductor is greatly improved.

In order to form the via-hole conductor having micropores, as the conductive paste for forming the via-hole conductor, a conductive paste containing resin powder (e.g., polypropylene resin powder) which is insoluble in the paste and is evaporable during firing may be used. In such a case, the content of the resin powder is preferably about 3% to about 40% by volume, and more preferably about 15% to about 25% by volume, relative to the total volume of the paste in view of the balance between the control of firing shrinkage behavior and the control of conductivity. For the same reason, the average particle size of the conductive paste is preferably about 0.1 μm to about 75 μm, and more preferably about 5 μm to about 50 μm.

Although the present invention has been described based on preferred embodiments with reference to the drawings, it is to be understood that the present invention is not limited to preferred embodiments described herein and that various modifications can be made within the scope of the present invention.

For example, although the via-hole conductor 25 and the connecting land 29 have substantially circular cross sections in the preferred embodiment shown in FIG. 1, at least one of them may have a cross section other than substantially circular.

In the preferred embodiment shown in FIG. 1, the connecting land 29 is positioned at the end of the line conductor 28. However, when the middle section of the line conductor is connected to the via-hole conductor, the connecting land may be located approximately in the middle of the line conductor.

As described above, in accordance with preferred embodiments of the present invention, the line conductor provided in the laminate including a plurality of ceramic layers, i.e., the line conductor extending at the interface between two ceramic layers, is connected to the via-hole conductor at the predetermined interface with the connecting land therebetween. The connecting land is provided on the line conductor and has a diameter greater than the diameter of the via-hole conductor, and the via-hole conductor is positioned in the approximate center of the connecting land. Therefore, even if the width of the line conductor is substantially equal to or less than the diameter of the via-hole conductor, disconnection between the line conductor and the via-hole conductor due to a difference in firing shrinkage behavior between the via-hole conductor and the ceramic layer, due to a deviation in lamination position when the ceramic layers are laminated, or due to a deviation in printing position when the line conductor is printed, can be prevented, and thus the reliability of connection between the line conductor and the via-hole conductor is greatly improved.

In preferred embodiments of the present invention, if the connecting land is integrally formed with the line conductor, since the connecting land can be simultaneously formed in the step of forming the line conductor, an additional step for forming the connecting land is not required. Thus, a decrease in productivity is prevented, and also the alignment of the connecting land and the line conductor is performed easily with high precision.

When the line conductor is connected to the via-hole conductor at the end thereof, connection failure more easily occurs in comparison with a case in which the line conductor is connected to the via-hole conductor at the center thereof. Therefore, preferred embodiments of the present invention are particularly effective when the connecting land is positioned at the end of the line conductor.

As described above, since the reliability of connection between the via-hole conductor and the line conductor is improved, by setting the diameter of the via-hole conductor at about 75 μm to about 150 μm, or by setting the width of the line conductor at about 30 μm to about 100 μm, reduction in the size of the monolithic ceramic electronic component and an increase in the density of the wiring can be advantageously achieved.

When the size reduction and the increase in density are performed, by setting the diameter of the connecting land to be greater than the diameter of the via-hole conductor by approximately about 100 μm to about 200 μm, it is possible to secure the reliability of connection regardless of a deviation in lamination of ceramic green sheets constituting the laminate.

In accordance with the method for manufacturing the monolithic ceramic electronic component of various preferred embodiments of the present invention, a connecting land having a diameter greater than the diameter of the via-hole conductor is formed simultaneously with the formation of the line conductor, with the via-hole conductor being positioned in the approximate center of the connecting land, prior to the step of producing a green laminate by laminating a plurality of ceramic green sheets so that the line conductor to be connected to the via-hole conductor is located at the interface between predetermined ceramic green sheets. Therefore, reliable connection between the via-hole conductor and the line conductor can be achieved when the green laminate is produced.

Since it is impossible to make corrections to improve the reliability of connection between the line conductor and the via-hole conductor once the green laminate has been produced, it is highly advantageous to produce a reliable connection between the via-hole conductor and the line conductor in the process of producing the green laminate.

In the method for manufacturing the monolithic ceramic electronic component of preferred embodiments of the present invention, if the connecting land is formed so as to have a pattern overlapping with the end surface of the via-hole conductor, it is possible to more reliably connect the connecting land and the via-hole conductor to each other.

If an electronic device is produced using the monolithic ceramic electronic component having the superior advantages described above, it is possible to improve the reliability of the electronic device even if the size of the electronic device is reduced and the performance demands thereon are increased.

While the invention has been particularly shown and described with reference to preferred embodiments thereof, it will be understood by those skilled in the art that the foregoing and other changes in form and details can be made without departing from the spirit and scope of the invention.

What is claimed is:

1. A monolithic ceramic electronic component comprising:
a laminate member including a plurality of ceramic layers; and
wiring conductors provided on selected ones of the ceramic layers, the wiring conductors including at least one via-hole conductor extending through the selected ones of the ceramic layers and at least one line conductor extending along an interface between the selected ones of the ceramic layers, the line conductor having a width that is substantially equal to or less than the diameter of the via-hole conductor, and the line conductor being connected to the via-hole conductor at the interface;
wherein the line conductor is provided with a connecting land having a diameter that is greater than the diameter of the via-hole conductor, the line conductor is connected to the via-hole conductor with the connecting land therebetween, and the via-hole conductor is positioned in the approximate central portion of the connecting land.

2. A monolithic ceramic electronic component according to claim 1, wherein the line conductor and the connecting land are integral and define a unitary member.

3. A monolithic ceramic electronic component according to claim 1, wherein the connecting land is positioned at an end of the line conductor.

4. A monolithic ceramic electronic component according to claim 1, wherein the via-hole conductor has a diameter of about 75 μm to about 150 μm.

5. A monolithic ceramic electronic component according to claim 4, wherein the connecting land has a diameter which is greater than the diameter of the via-hole conductor by about 100 μm to about 200 μm.

6. A monolithic ceramic electronic component according to claim 1, wherein the line conductor has a width of about 30 μm to about 100 μm.

7. A monolithic ceramic electronic component according to claim 6, wherein the connecting land has a diameter which is greater than the diameter of the via-hole conductor by about 100 μm to about 200 μm.

8. A monolithic ceramic electronic component according to claim 1, wherein the via-hole conductor has micropores therein.

9. A method for manufacturing a monolithic ceramic electronic component, the method comprising the steps of:
preparing a plurality of ceramic green sheets, each of the plurality of ceramic green sheets being backed with a carrier film;
forming a through-hole through the ceramic green sheet and the carrier film;
injecting a conductive paste into the through-hole from the side of the carrier film using the carrier film as a mask in order to form a via-hole conductor in the through-hole;
applying the conductive paste by printing on a principal surface of the ceramic green sheet backed with the carrier film in order to form a line conductor to be connected to the via-hole conductor;
separating the carrier film from the ceramic green sheet;
producing a green laminate by laminating the plurality of ceramic green sheets so that the line conductor is positioned at an interface between selected ones of the ceramic green sheets; and
firing the green laminate;
wherein, in the step of applying the conductive paste for forming the line conductor, a connecting land having a diameter which is greater than the diameter of the via-hole conductor is formed while the via-hole conductor is positioned in the approximate center of the connecting land.

10. A method according to claim 9, wherein the connecting land is formed so as to have a pattern overlapping with an end surface of the via-hole conductor.

11. A method according to claim 9, wherein the line conductor and the connecting land are integrally formed.

12. A method according to claim 9, wherein the connecting land is positioned at an end of the line conductor.

13. A method according to claim 9, wherein the via-hole conductor has a diameter of about 75 μm to about 150 μm.

14. A method according to claim 13, wherein the connecting land has a diameter which is greater than the diameter of the via-hole conductor by about 100 μm to about 200 μm.

15. A method according to claim 9, wherein the line conductor has a width of about 30 μm to about 100 μm.

16. A method according to claim 15, wherein the connecting land has a diameter which is greater than the diameter of the via-hole conductor by about 100 μm to about 200 μm.

17. A method according to claim 9, wherein the via-hole conductor has micropores therein.

18. An electronic device comprising a monolithic ceramic electronic component according to claim 1 and a wiring substrate mounting the monolithic ceramic electronic component.
